(19) United States
(12) Patent Application Publication
(10) Pub. No.: US 2025/0306369 A1
(43) Pub. Date: Oct. 2, 2025

(54) HEAD-UP DISPLAY DRIVING MODULE

(71) Applicant: HYUNDAI MOBIS CO., LTD., Seoul (KR)

(72) Inventor: Byung Ki KIM, Yongin-si (KR)

(73) Assignee: HYUNDAI MOBIS CO., LTD., Seoul (KR)

(21) Appl. No.: 19/080,096

(22) Filed: Mar. 14, 2025

(30) Foreign Application Priority Data
Mar. 26, 2024 (KR) 10-2024-0041185

(51) Int. Cl. G02B 27/01; B60K 35/233

(52) U.S. Cl. CPC G02B 27/0149; B60K 35/233; G02B 27/0101; B60K 2360/23; G02B 2027/0154

(57) ABSTRACT

A head-up display driving module includes an aspheric mirror, a driver including a motor to rotate the aspheric mirror by raising or lowering a link part on a lead screw, a lead screw bracket to fix the lead screw, the lead screw bracket attached to a front motor mount of the motor, a damping member fixedly disposed, using shoulder bolts, between the lead screw bracket and the front motor mount, a rear motor mount at a rear of the motor, a plurality of absorbers disposed at the rear motor mount, the plurality of dynamic vibration absorbers protruding forward from the rear motor mount, and a coupling including a driving hub connected to the rotation shaft of the motor, a driven hub coupled to the lead screw, and a spacer disposed between the driving hub and the driven hub, wherein the spacer or the driven hub includes an inertial body.

### CROSS-REFERENCE TO RELATED APPLICATION(S)

The present application claims the benefit under 35 USC § 119(a) of Patent Application No. 10-2024-0041185, filed on Mar. 26, 2024, in the Korean Intellectual Property Office, the entire disclosure of which is incorporated herein by reference for all purposes.

### BACKGROUND

### 1. Field

The present disclosure relates to a head-up display driving module.

### 2. Description of the Related Art

The following description merely provides background information related to the present embodiment, and does not constitute the related art.

A head-up display is a device that displays onto a windshield, i.e., a vehicle's front window, an image that contains information such as vehicle speed, remaining amount of fuel, and navigation. The head-up display is configured to present display information projected from a picture generation unit onto the windshield.

A head-up display according to the conventional art rotates an aspheric mirror by using a motor. Here, the aspheric mirror receives torque by making point contact with a power transmission unit which transmits the torque of the motor. When the aspheric mirror and makes point contact with the power transmission unit, an external force caused by the motor's vibration and friction is concentrated at one point, which may lead to wear and geometric transformation of the aspheric mirror.

A problem with the head-up display according to the conventional art is that, when the motor is run at high rpm, the vibration of the motor cannot be dampened, thus causing noise.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

A head-up display driving module according to an embodiment is capable of dampening the vibration of the motor by using a damping member disposed between a front motor mount and a lead screw bracket.

A head-up display driving module according to an embodiment is capable of dampening the vibration of the motor by using a plurality of dynamic vibration absorbers attached to and disposed on a rear motor mount.

A head-up display driving module according to an embodiment helps can rotate accurately to match the frequency of the input pulse signal of the motor in a high-speed area and can increase the maximum number of rotations of the motor, by reducing the vibration of the motor by using an inertial body disposed within a coupling that extends to and is connected to a rotating shaft of the motor.

A head-up display driving module according to an embodiment is capable of improving assemblability by adjusting the coupling angle of the rear motor mount and the coupling positions of the plurality of dynamic vibration absorbers.

The aspects of the present disclosure are not limited to the foregoing, and other aspects not mentioned herein will be able to be clearly understood by those skilled in the art from the following description.

According to an embodiment, a head-up display driving module has the effect of dampening the vibration of the motor by using a damping member disposed between a front motor mount and a lead screw bracket.

According to an embodiment, a head-up display driving module has the effect of dampening the vibration of the motor by using a plurality of dynamic vibration absorbers attached to and disposed on a rear motor mount.

According to an embodiment, a head-up display driving module can rotate accurately to match the frequency of the input pulse signal of the motor in a high-speed area and can increase the maximum number of rotations of the motor, by reducing the vibration of the motor by using an inertial body disposed within a coupling that extends to and is connected to a rotating shaft of the motor.

According to an embodiment, a head-up display driving module has the effect of improving assemblability by adjusting the coupling angle of the rear motor mount and the coupling positions of the plurality of dynamic vibration absorbers.

In one general aspect, a head-up display driving module includes an aspheric mirror, a driver including a motor to rotate the aspheric mirror by raising or lowering a link part on a lead screw based on a driving force of the motor, a lead screw bracket to fix the lead screw, the lead screw bracket being attached to a front motor mount formed at a front of the motor, a damping member fixedly disposed, using shoulder bolts, between the lead screw bracket and the front motor mount, a rear motor mount coupled to a rear of the motor, a plurality of dynamic vibration absorbers disposed on and coupled to the rear motor mount around a rotation shaft of the motor, the plurality of dynamic vibration absorbers protruding forward from the rear motor mount, and a coupling including a driving hub connected to the rotation shaft of the motor, a driven hub coupled to the lead screw, and a spacer disposed between the driving hub and the driven hub, wherein the spacer or the driven hub includes an inertial body.

The spacer may include an elastic material, and spacer may have an outer diameter that is larger than outer diameters of the driving hub and the driven hub, and the inertial body may be formed inside the spacer.

The spacer may have a greater moment of inertia than the motor.

The inertial body may be molded in the spacer along the outer diameter of the coupling, and/or a plurality of inertial bodies are provided and assembled in the spacer along the outer diameter of the coupling in such a way as to be spaced apart from one another.

The driven hub may have an outer diameter that is larger than the outer diameters of the driving hub and the spacer, and the driven hub may have a mass that constitutes the inertial body.

The driven hub may have a greater moment of inertia than the motor.

The rear motor mount may be attached to the rear of the motor at an angle with respect to the front motor mount, to prevent physical interference between the shoulder bolts and the plurality of dynamic vibration absorbers.

The plurality of dynamic vibration absorbers may be attached forward of the rear motor mount for ease of assembly.

The plurality of dynamic vibration absorbers may be fastened to a burring tap formed on the rear motor mount, and/or welded to the rear motor mount.

In one general aspect, a head-up display for a vehicle includes an aspheric mirror connected to a link part that is disposed on a lead screw, a driver to drive the link part along the lead screw, the driver including a motor to perform the driving of the link part using a rotation shaft of the motor, a front motor mount disposed at a front of the motor, and a rear motor mount disposed at a rear of the motor, a lead screw bracket attached to the front motor mount, a damping member disposed between the lead screw bracket and the front motor mount, one or more dynamic vibration absorbers at the rear motor mount around a line corresponding to a longitudinal axis of the rotating shaft, a driving hub connected to the rotating shaft, a driven hub coupled to the lead screw, and a spacer disposed between the driving hub and the driven hub, where the driven hub or the spacer respectively has a greater moment of inertia than the motor.

The damping member may be fixed, using shoulder bolts, between the lead screw bracket and the front motor mount.

The one or more dynamic vibration absorbers protrude forward from the rear motor mount.

The spacer may include an elastic material, and the spacer may have an outer diameter that may be larger than outer diameters of the driving hub and the driven hub, and/or the spacer includes one or more inertial bodies disposed inside the spacer to result in the greater moment of inertia than the motor compared to another moment of inertia of the spacer without the one or more inertial bodies.

The driven hub may have an outer diameter that is larger than the outer diameters of the driving hub and the spacer.

The one or more dynamic vibration absorbers may be fastened to a burring tap disposed on the rear motor mount, or welded to the rear motor mount.

The effects of the present disclosure are not limited to the foregoing, and other effects not mentioned herein will be able to be clearly understood by those skilled in the art from the following description.

### BRIEF DESCRIPTION OF THE DRAWINGS

FIG. 1 is a perspective view of a head-up display driving module according to an embodiment of the present disclosure.

FIG. 2 is an exploded perspective view of a head-up display driving module according to an embodiment of the present disclosure.

FIG. 3 is an exploded perspective view of a coupling according to another embodiment of the present disclosure.

FIG. 4 is a perspective view of a head-up display driving module according to an embodiment of the present disclosure when viewed from the rear.

FIG. 5 is a cross-sectional view taken along the line A-A of FIG. 1.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit,’ ‘module,’ and the like refer to one or more units for processing at least one function or operation, which may be implemented by hardware, software, or a combination thereof.

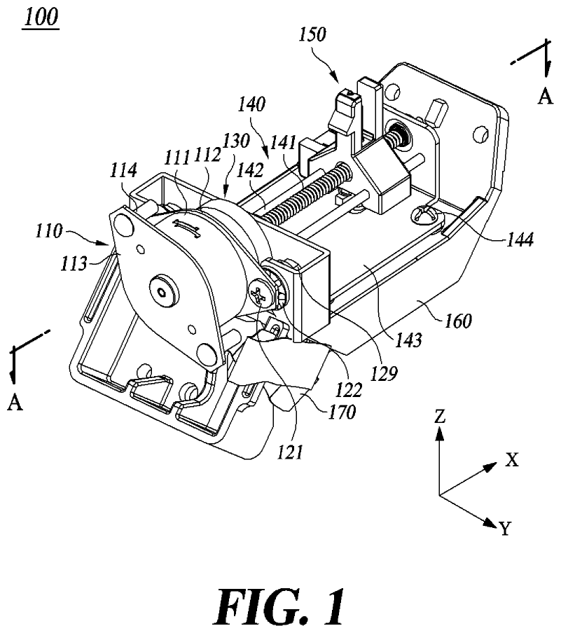

FIG. 1 is a perspective view of a head-up display driving module according to an embodiment of the present disclosure.

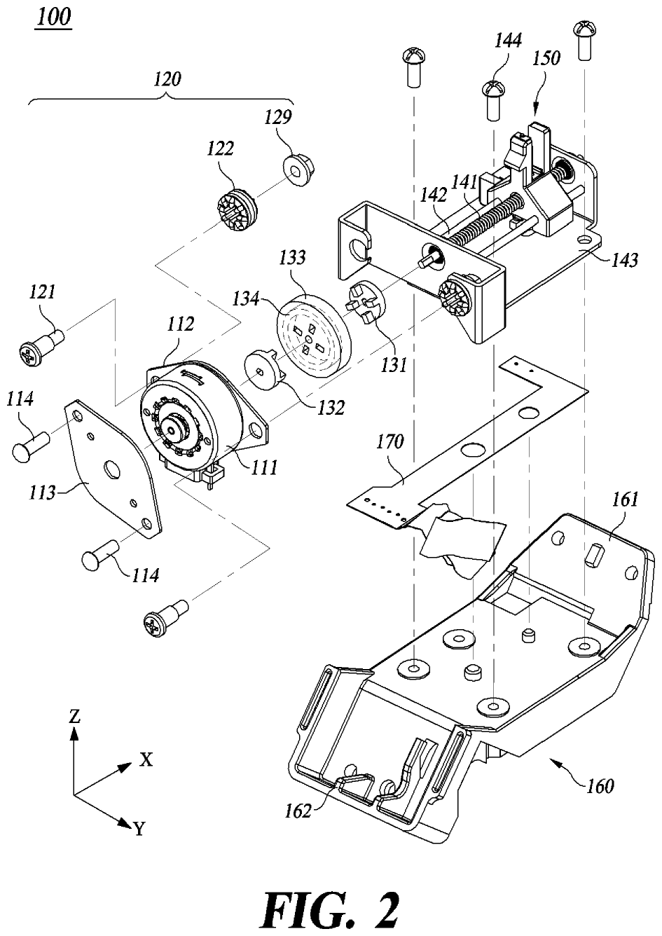

FIG. 2 is an exploded perspective view of a head-up display driving module according to an embodiment of the present disclosure.

Referring to FIG. 1 and FIG. 2, a head-up display driving module 100 according to an embodiment of the present disclosure includes some or all of a power generating unit 110, a damping unit 120, a coupling 130, a power transmission unit 140, a link part 150, and a housing 160.

The power generating unit 110 includes a motor 111, a front motor mount 112, a rear motor mount 113, and a plurality of dynamic vibration absorbers 114.

The head-up display driving module 100 rotates an aspheric mirror (not shown) by raising or lowering the link part 140 based on a driving force of the motor 111.

The motor 111 is disposed on one side of the housing 160. In the power generating unit 110, a rotating shaft of the motor 111 extends to and is attached to a lead screw 141 by using the coupling 130. The lead screw 141 is configured to extend to and be attached to the rotating shaft of the motor 111 so as to be rotatable, and may be formed integrally with the power generating unit 110 or be made detachable from it so as to allow for assembling and removal.

The motor 111 may be a DC motor, an AC motor, an induction motor, a synchronous motor, a step motor, a servo motor, a brushless motor, a linear motor, or a permanent magnet synchronous motor (PMSM).

The motor 111 may be connected to a lead screw bracket 143 by using the front motor mount 112. The front motor mount 112 is formed to adjoin one front face of the motor 111.

The front motor mount 112 protrudes partially in the y axis direction and (−)y axis direction shown in FIG. 1, so as to be attached to the lead screw bracket 143 by using shoulder bolts 121.

The rear motor mount 113 is disposed to adjoin the rear of the motor 111.

The rear motor mount 113 may be formed to correspond in shape to the front motor mount 112. However, the shape of the rear motor mount 113 is not limited to the shape of the front motor mount 112.

The plurality of dynamic vibration absorbers 114 are attached to the rear motor mount 113 by penetrating it. The shape of the rear motor mount 113 may be determined based on the number of dynamic vibration absorbers 114. As illustrated in FIGS. 1 and 2, the plurality of dynamic vibration absorbers may be disposed on and coupled to the rear motor mount around the rotating shaft, i.e., the plurality of dynamic vibration absorbers may be disposed about or around, such as within a plane in the Y and Z axes in FIG. 1 as a non-limiting example, a line corresponding to the longitudinal axis of the rotating shaft of the motor 111.

Although FIGS. 1 and 2 illustrate two dynamic vibration absorbers 114, the number of dynamic vibration absorbers 114 is not limited to this. For example, if there are three or more dynamic vibration absorbers 114, the rear motor mount 113 may have a given shape so that the plurality of dynamic vibration absorbers 114 all penetrate and are attached to it.

The rear motor mount 113 according to an embodiment of the present disclosure may be manufactured from a thin metal sheet.

The plurality of dynamic vibration absorbers 114 may be in the shape of a bolt with a thread. The plurality of dynamic vibration absorbers 114 generate a coupling force by being fitted into through-holes formed in the rear motor mount 113.

The plurality of dynamic vibration absorbers 114 may be formed in the shape of a cantilever.

The plurality of dynamic vibration absorbers 114 are attached to the rear motor mount 113 in the x axis direction shown in FIG. 1. This is to make it easier to assemble together the shoulder bolts 121, which generate a coupling force between the front motor mount 112 and the lead screw bracket 132, and the plurality of dynamic vibration absorbers 114.

For example, in a case where the shoulder bolts 121 are attached in the x axis direction to the front motor mount 112 and the lead screw bracket 143 and the plurality of dynamic vibration absorbers 114 are attached in the (−)x axis direction which is the opposite direction of the x axis direction, this may result in a decrease in the ease of assembling and cause interference during maintenance and repair.

The plurality of dynamic vibration absorbers 114 may dampen vibrations generated from the motor 111. The length of the plurality of dynamic vibration absorbers 114 may be adjusted so as to have the same frequency as a natural frequency which is a frequency of rotation of the motor 111. For example, the length of threads of the plurality of dynamic vibration absorbers 114 may be adjusted lengthwise based on the shape of a bolt.

The damping unit 120 includes a damping member 122, shoulder bolts 121, and nuts 129.

The damping unit 120 is configured to dampen vibrations generated from the motor 111 that are transmitted to the lead screw bracket 143 via the front motor mount 112.

The damping member 122 is disposed to correspond to through-holes formed in the front motor mount 112 and the lead screw bracket 143. The damping member 122 generates a coupling force by using the shoulder bolts 121 and the nuts 129.

The damping member 122 may be formed from a rubber material.

The coupling 130 according to an embodiment of the present disclosure may be a flexible coupling.

When a driving force produced by the rotation of the rotating shaft of the motor 111 is transmitted to the lead screw 141, the coupling 130 corrects the eccentricity between the rotating shaft of the motor 111 and a rotating shaft of the lead screw 141. Thus, even if the rotating shaft of the motor 111 and the rotating shaft of the lead screw 141 do not coincide with each other, the coupling 130 may minimize loss of the driving force of the motor 111 when transmitting the driving force to the lead screw 141, based on an assembly tolerance of the head-up display driving module 100.

The coupling 130 includes a driving hub 132, a spacer 133, and an driven hub 131.

The driving hub 132 is connected to the rotating shaft of the motor 111. The driven hub 131 is connected to one end of the lead screw 141. The driving hub 132 and the driven hub 131 have jaws, respectively, that are formed on one side or the other side, for coupling with the spacer 133.

The spacer 133 is disposed between the driving hub 132 and the driven hub 131. The spacer 133 includes holes for coupling with the jaws formed on the driving hub 132 and the driven hub 131.

The coupling 130 according to an embodiment of the present disclosure includes an inertial body 134. The head-up display driving module 100 may reduce vibrations in a resonance area of the motor 111 by using the coupling 130 including the inertial body 134.

Moreover, the head-up display driving module 100 helps follow the pulse rate of the motor 111 in a high-speed area and can increase the maximum number of rotations of the motor 111, by using the coupling 130 including the inertial body 134. Here, the following of the pulse rate of the motor 111 means that the rotational speed of the motor 111 stably follows the rate of a pulse signal even in a high-speed area.

In the coupling 130 according to an embodiment of the present disclosure, the inertial body 134 may be insert-molded in the spacer 133. The inertial body 134 may be formed inside the spacer 133. That is, the inertial body 134 may be formed integrally with the spacer 133.

The inertial body 134 has a certain mass. The mass of the inertial body 134 may be determined based on the natural frequency of the motor 111. The mass of the inertial body 134 may be determined before the step of assembling the head-up display driving module 100.

Although not shown in FIG. 2, the inertial body 134 may be assembled in an axial direction of the spacer 133. Due to this, the spacer 133 may include a receiving space (not shown) for assembling/removing the inertial body 134. Preferably, the receiving space may be formed in such a way as not to interfere with holes that couple with the driving hub 132 and the driven hub 131, with respect to the axial direction of the spacer 133. When there are a plurality of inertial bodies 134, the number of receiving spaces corresponds to the number of inertial bodies 134. Here, the receiving space may be formed in the shape of a hole that penetrates the spacer 133, but is not limited to such a shape.

The power transmission unit 140 includes a lead screw 141, guide shafts 142, and a lead screw bracket 143.

The lead screw bracket 143 is connected to and adjoins a main body of the housing 160. The lead screw bracket 143 is fixed to the housing 160 by using tapping screws 144.

The lead screw bracket 143 allows the lead screw 141 to be fixed to the housing 160 on lower and upper surfaces which are partially bent with respect to a surface that adjoins the housing 160, for example, in the z axis direction. Here, the upper surface of the lead screw bracket 143 is disposed in parallel to the front motor mount 112, and they are attached together by using the shoulder bolts 121 of the damping unit 120.

The lead screw bracket 143 rotatably holds a longitudinal end of the lead screw 141. The lead screw 141 may be fixed onto the lead screw bracket 143 by using a bearing. Here, the bearing may be disposed on the upper and lower surfaces of the lead screw bracket 143.

The guide shafts 142 are placed parallel to each other on the lead screw bracket 143, spaced apart from the lead screw 141 in the y axis direction and the (−)y axis direction, respectively. The guide shafts 142 are disposed on opposite sides of the lead screw 141. The guide shafts 142 are disposed to penetrate part of the link part 150 which will be described below. Thus, when the link part 150 moves up and down the lead screw 141, the guide shafts 142 may guide the link part 150 along an up-and-down section so as to keep the link part 150 from rotating about the thread of the lead screw 141.

The link part 150 includes a body (not shown), a slot (not shown), and a clip (not shown).

The link part 150 is partially coupled to the lead screw 141 so as to move up and down the up-and-down section on the lead screw 141. The link part 150 includes a hole (not shown) with a thread that is formed inside the body so as to be coupled to the lead screw 141.

The slot of the link part 150 extends heightwise from the body, and has one open U-shaped side. The clip is formed in a U-shape so as to correspond to the open side of the slot and attached to the slot by a snap-fit. Here, the clip is made detachable from the slot.

The housing 160 allows the head-up display driving module 100 to be fixed into a head-up display.

The housing 160 includes a lower housing 161 and an upper housing 162.

The upper housing 162 and the lower housing 161 are diagonally slanted from the body of the housing 160. Here, the body of the housing 160 is connected to and adjoins one side of the lead screw bracket 143.

The housing 160 includes a plurality of bosses (not shown) and holes (not shown) for fixing the lead screw bracket 143 in place. Here, the plurality of bosses and holes are formed in the z axis direction shown in FIG. 2 on the body of the housing 160. When the lead screw bracket 143 is assembled to the housing 160, its position is determined based on the plurality of bosses, and the tapping screws 144 are fastened through the lead screw bracket 143 to the holes formed on the housing.

A cable slit is attached between the housing 160 and the lead screw bracket 143. Here, the cable slit refers to a conductive wire that is connected to the motor 111, i.e., a flexible cable 170. It is possible to install the flexible cable 170 in such a way as to be exposed in both left and right directions with respect to the housing 160.

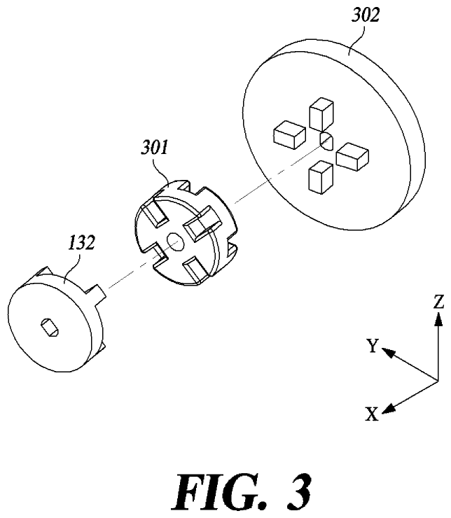

FIG. 3 is an exploded perspective view of a coupling according to another embodiment of the present disclosure.

Referring to FIGS. 1 to 3, the coupling 130 according to another embodiment of the present disclosure forms an inertial hub 302 having inertia by adjusting the weight and diameter of the driven hub. Here, the inertial hub 302 has a greater moment of inertia than the motor 111. Assuming that the inertial hub 302 has a circular shape, the moment of inertia of the inertial hub 302 may be determined based on the mass and/or diameter of the inertial hub 302.

As illustrated in FIG. 3, the outer diameter of the inertial hub 302 may have a circular shape. Preferably, the outer diameter of the inertial hub 302 may have a circular shape in order to minimize friction with air when the coupling 130 rotates. However, the outer diameter of the inertial hub 302 is not limited to a circular shape.

The coupling 130 according to another embodiment of the present disclosure includes an insert 301 between the inertial hub 302 and the driving hub 132.

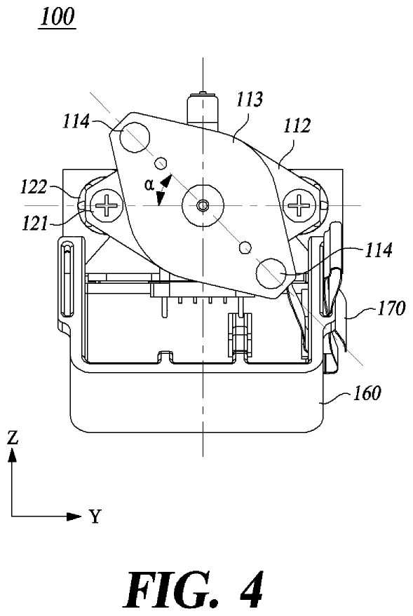

FIG. 4 is a perspective view of a head-up display driving module according to an embodiment of the present disclosure when viewed from the rear.

Referring to FIG. 1, FIG. 2, and FIG. 4, the rear motor mount 113 is attached to the rear of the motor 111 at a given angle with respect to the front motor mount 112. This is to prevent the plurality of dynamic vibration absorbers 114 attached to the rear motor mount 113 from interfering with the shoulder bolts 121 attached to the front motor mount 112.

For example, a first imaginary line is formed by the two shoulder bolts 121 shown in FIG. 4 and passes through the rotating shaft of the motor 111, a second imaginary line is parallel to the z axis and passes through the rotating shaft of the motor 111, and a third imaginary line is formed by two dynamic vibration absorbers 114 attached to the rear motor mount 113. The third imaginary line may be disposed at an angle a with respect to the first imaginary line. Here, the angle a may range from 15° to 165°, for example.

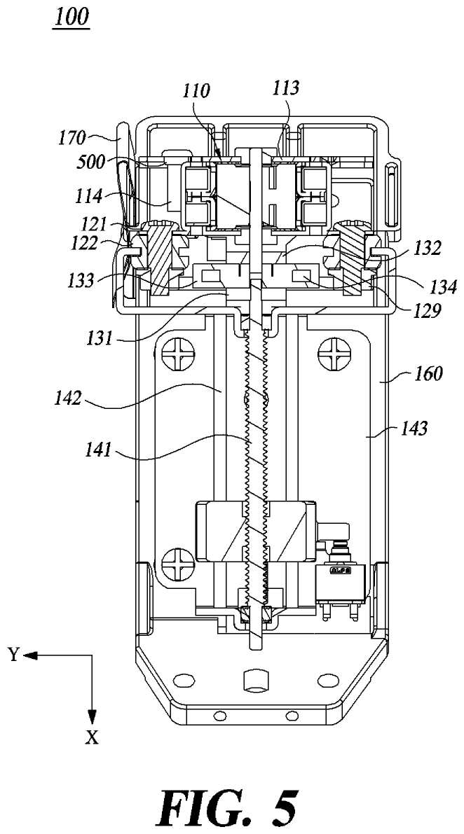

FIG. 5 is a cross-sectional view taken along the line A-A of FIG. 1.

Referring to FIG. 1, FIG. 2, FIG. 4, and FIG. 5, the plurality of dynamic vibration absorbers 114 according to an embodiment of the present disclosure are fitted into the through-holes of the rear motor mount 113 and then welded. For example, the plurality of dynamic vibration absorbers 114 may generate a coupling force with the rear motor mount 113 by forming welding beads 500. However, the method of how the plurality of dynamic vibration absorbers 114 generate a coupling force is not limited to the above.

The plurality of dynamic vibration absorbers 114 according to another embodiment of the present disclosure also may generate a coupling force by being fastened based on a burring tap formed on the rear motor mount 113. The burring tap may be formed by burring the rear motor mount 113 which is made of a thin sheet material and then tapping it. The plurality of dynamic vibration absorbers 114 having a thread are attached to the rear motor mount 113 by engaging a thread formed on the inside of the burring tap.

The plurality of dynamic vibration absorbers 114 according to yet another embodiment of the present disclosure may generate a coupling force by being fitted into the through-holes formed in the rear motor mount 113 and then compressed by pressing. Here, the plurality of dynamic vibration absorbers 114 according to yet another embodiment of the present disclosure are formed in the shape of a bolt with a thread, with toothed protrusions formed under the head of the bolt. Thus, when the plurality of dynamic vibration absorbers 114 are compressed against the rear motor mount 113 by pressing, the toothed protrusions may plastically deform part of the rear motor mount 113, thereby generating rotational resistance, i.e., a fastening force, between the plurality of dynamic vibration absorbers 114 and the rear motor mount 113.

According to an embodiment, a vibration damping device for the head-up display driving module 100 has the effect of dampening the vibration of the motor by using a damping member 122 disposed between a front motor mount 112 and a lead screw bracket 143.

According to an embodiment, a vibration damping device for the head-up display driving module 100 has the effect of dampening the vibration of the motor 111 by using a plurality of dynamic vibration absorbers 114 attached to and disposed on a rear motor mount 113.

According to an embodiment, a vibration damping device for the head-up display driving module 100 can rotate accurately to match the frequency of the input pulse signal of the motor 111 in a high-speed area and increasing the maximum number of rotations of the motor 111, by reducing the vibration of the motor 111 by using an inertial body 134 disposed within a coupling 130 that extends to and is attached to a rotating shaft of the motor 111.

According to an embodiment, a vibration damping device for the head-up display driving module 100 has the effect of improving assemblability by adjusting the coupling angle of the rear motor mount 113 and the coupling positions of the plurality of dynamic vibration absorbers 114.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A head-up display driving module comprising:
an aspheric mirror;
a driver comprising a motor to rotate the aspheric mirror by raising or lowering a link part on a lead screw based on a driving force of the motor;
a lead screw bracket to fix the lead screw, the lead screw bracket being attached to a front motor mount formed at a front of the motor;
a damping member fixedly disposed, using shoulder bolts, between the lead screw bracket and the front motor mount;
a rear motor mount coupled to a rear of the motor;
a plurality of dynamic vibration absorbers disposed on and coupled to the rear motor mount around a rotation shaft of the motor, the plurality of dynamic vibration absorbers protruding forward from the rear motor mount; and
a coupling including:
a driving hub connected to the rotation shaft of the motor;
a driven hub coupled to the lead screw; and
a spacer disposed between the driving hub and the driven hub,
wherein the spacer or the driven hub includes an inertial body.

2. The head-up display driving module of claim 1,
wherein the spacer comprises an elastic material, and spacer has an outer diameter that is larger than outer diameters of the driving hub and the driven hub, and
wherein the inertial body is formed inside the spacer.

3. The head-up display driving module of claim 2, wherein the spacer has a greater moment of inertia than the motor.

4. The head-up display driving module of claim 2, wherein, at least one of the inertial body is molded in the spacer along the outer diameter of the coupling, or a plurality of inertial bodies are provided and assembled in the spacer along the outer diameter of the coupling in such a way as to be spaced apart from one another, or a combination thereof.

5. The head-up display driving module of claim 1,
wherein the driven hub has an outer diameter that is larger than the outer diameters of the driving hub and the spacer, and the driven hub has a mass that constitutes the inertial body.

6. The head-up display driving module of claim 5, wherein the driven hub has a greater moment of inertia than the motor.

7. The head-up display driving module of claim 1, wherein the rear motor mount is attached to the rear of the motor at an angle with respect to the front motor mount, to prevent physical interference between the shoulder bolts and the plurality of dynamic vibration absorbers.

8. The head-up display driving module of claim 1, wherein the plurality of dynamic vibration absorbers are attached forward of the rear motor mount for ease of assembly.

9. The head-up display driving module of claim 1, wherein the plurality of dynamic vibration absorbers are, at least one of:
fastened to a burring tap formed on the rear motor mount; or
welded to the rear motor mount; or
a combination thereof.

10. A head-up display for a vehicle, the head-up display comprising:
an aspheric mirror connected to a link part that is disposed on a lead screw;
a driver to drive the link part along the lead screw, the driver comprising:
a motor to perform the driving of the link part using a rotation shaft of the motor;
a front motor mount disposed at a front of the motor; and
a rear motor mount disposed at a rear of the motor;
a lead screw bracket attached to the front motor mount;
a damping member disposed between the lead screw bracket and the front motor mount;
one or more dynamic vibration absorbers at the rear motor mount around a line corresponding to a longitudinal axis of the rotating shaft;
a driving hub connected to the rotating shaft;
a driven hub coupled to the lead screw; and
a spacer disposed between the driving hub and the driven hub,
wherein the driven hub or the spacer respectively has a greater moment of inertia than the motor.

11. The head-up display of claim 10, wherein the damping member is fixed, using shoulder bolts, between the lead screw bracket and the front motor mount.

12. The head-up display of claim 10, wherein the one or more dynamic vibration absorbers protrude forward from the rear motor mount.

13. The head-up display of claim 10,
wherein the spacer comprises an elastic material, and the spacer has an outer diameter that is larger than outer diameters of the driving hub and the driven hub, or
wherein the spacer includes one or more inertial bodies disposed inside the spacer to result in the greater moment of inertia than the motor compared to another moment of inertia of the spacer without the one or more inertial bodies.

14. The head-up display of claim 10, wherein the driven hub has an outer diameter that is larger than the outer diameters of the driving hub and the spacer.

15. The head-up display of claim 10, wherein the one or more dynamic vibration absorbers are:
fastened to a burring tap disposed on the rear motor mount; or
welded to the rear motor mount.
